(19) United States
(12) Patent Application Publication
(10) Pub. No.: US 2011/0240697 A1
(43) Pub. Date: Oct. 6, 2011

(54) Travel utility tray

(76) Inventor: Rachel Stephens, Fort Worth, TX (US)

(21) Appl. No.: 12/798,403

(22) Filed: Apr. 2, 2010

(51) Int. Cl. B60R 7/00; B65D 25/20; B65D 25/22

(52) U.S. Cl. 224/400; 220/737; 220/751

(57) ABSTRACT

A travel utility tray for use in a vehicle is provided including a box having a rectangular base, a back side, a front side and two ends. Attached to the box is a tray-holder hanger having two parallel hanger portions and a cross-member holding the parallel hanger portions together. Each hanger portion has an upper curved end that is sized to hang over an interior portion of a vehicle, and a lower tray-holder end. Cup holder rings are attached to the back side of the box.

### BACKGROUND OF THE INVENTION

1. Field of the Invention

This invention relates to trays used for holding food and other items, and in particular relates to a travel utility tray for use in automobiles.

2. Description of the Related Art

Every day many people spend much time in their cars driving to work or working from their cars, or going on long vacations. The daily routine of many people includes long hours spent in cars eating, working, playing and resting. This results in people having many items scattered around their car, which is messy and can make it hard to find particular items. Holding food in one's lap or putting it on the car seat next to one can make it hard to eat. A tray allows the food to be kept in one place and not be scattered, as well as providing a place for other items to be placed.

There are a number of different types of trays that exist to help address this problem. Most of these trays are held on the person's lap, which means one less hand for use because one hand needs to hold the tray. Many of these trays are meant for use by only one person and only have one cup holder. Many vehicles do not have cup holders for all the seats, particularly for the back seats. Therefore not all people in the car have a place to put their cups, and they must have their own tray.

Many trays are also flat and have no edge or only a small raised edge, and cannot be used to store items while the car is moving because items on the tray are likely to fall off the tray on to the seat or floor of the car. Other trays are designed for particular locations in the car and are not adjustable for different locations or vehicles.

There is also a need in cars for a place to dispose of waste, such as food wrappers and the like.

It is therefore an object of the invention to provide a travel utility tray for holding food and beverages, as well as other items. It is a further object of the invention to provide a travel utility tray that enables disposal of waste items.

Other objects and advantages will be more fully apparent from the following disclosure and appended claims.

### SUMMARY OF THE INVENTION

The invention herein is a travel utility tray for use in a vehicle to hold food and drink items, as well as to have space for other items. The travel utility tray includes a box having a rectangular base, a back side, a front side and two ends. Attached to the box is a tray-holder hanger having two parallel hanger portions and a cross-member holding the parallel hanger portions together. Each hanger portion has an upper curved end that is sized to hang over an interior portion of a vehicle, and a lower tray-holder end. Cup holder rings are attached to the back side of the box.

Other objects and features of the inventions will be more fully apparent from the following disclosure and appended claims.

### BRIEF DESCRIPTION OF THE DRAWINGS

FIG. 1 is a perspective view of the fully assembled travel utility tray of the invention.

FIG. 2 is a perspective view showing the travel utility tray of the invention hanging from a steering wheel.

FIG. 3 is a perspective view showing the travel utility tray of the invention having from the back of a front seat of a vehicle.

FIG. 4 is a perspective view of a tray-holder hanger of the invention.

### DETAILED DESCRIPTION OF THE INVENTION AND PREFERRED EMBODIMENTS THEREOF

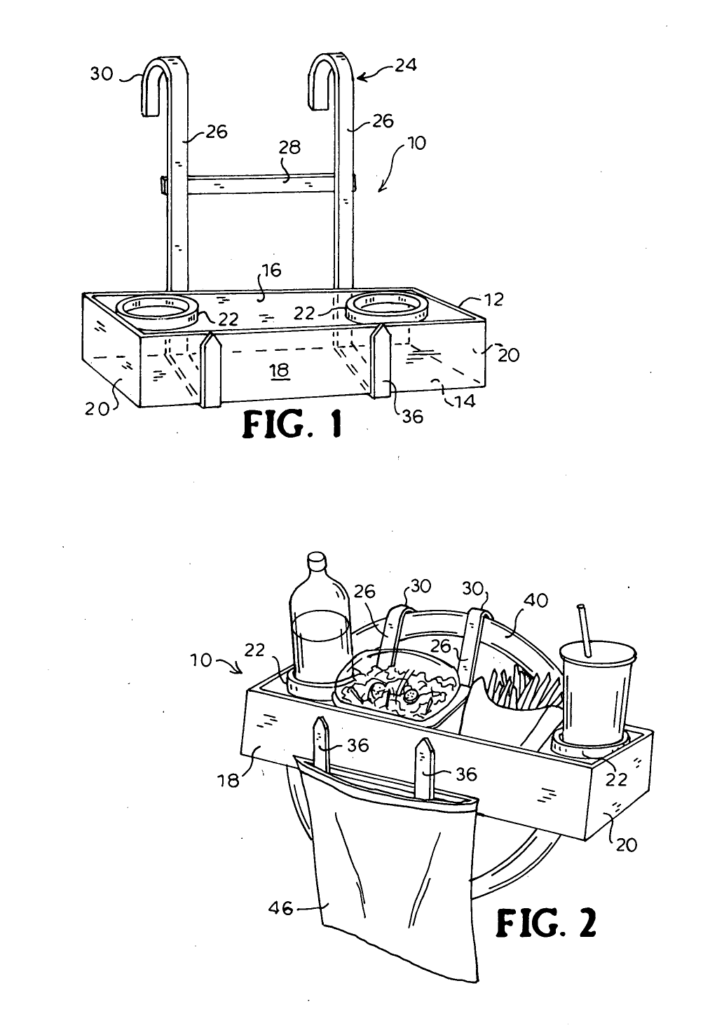

The present invention is a travel utility tray for use in a vehicle. Referring now to the figures, the travel utility tray 10 of the invention comprises a box 12, which may be made of sturdy plastic or other materials known in the art for trays and the like. The box 12 of the invention has a rectangular base 14, a back side 16, a front side 18 and two ends 20 as shown in FIG. 1. Preferably the back side 16, front side 18 and ends 20 of the box 12 are the same height. For standard use, a box 12 having dimensions of a box width between the ends 20 of 16 inches, a box depth of 4 1/2 inches, and a side/end height of 2 1/2 inches has sufficient interior space for two cup holders 22, a burger or sandwich, and additional items that the passenger or driver may wish to place there, such a child's toys, a flashlight, and the like. Sides that are about 2 1/2 inches high keep items placed in the box from rolling or falling out when the car is in motion or if the box is not hung securely or evenly. Smaller boxes or larger boxes, or boxes with different dimensions may be made without departing from the invention herein.

The invention further includes a tray-holder hanger 24 comprising two parallel hanger portions 26 and a cross-member 28 holding the parallel hanger portions 26 together. Each hanger portion 26 comprises an upper curved end 30 that is sized to hang over an interior portion of a vehicle, such as the steering wheel or a seat back or window opening, and a lower tray-holder end 32 having a flat lower portion 34 between a front portion 36 and a back portion 38, so that the box 12 fits snugly on the flat lower portion and is held there by the front and back portions (36, 38) of the two parallel hanger portions 26. The hanger portions are preferably made of plastic or aluminum or other sturdy material as known in the art. Preferably the top of the front portion 36 of each parallel hanger portion 26 is pointed as shown in FIG. 4 for use in attaching a trash bag 46 as discussed below. Optionally, the upper curved end 30 may be covered with a sleeve 44 of fabric or other flexible material to soften the edges, particularly if the upper curbed end 30 is made of a material with sharp or abrasive edges, and to improve or vary the appearance of the invention.

The length of the parallel hanger portions is such that the box 12 preferably hangs from a surface so that the top of the box 12 is about 5-8 inches below the surface from which the box 12 is hung. The length of the parallel hanger portions for a box 12 may be manufactured longer or shorter without departing from the invention herein. When there is more than one tray-holder hanger 24 (one set of parallel hanger portions 26) provided for use with the box 12, they may be interchangeably be attached to the box 12 by mean of hook and loop fasteners (such as VELCROTM) placed on the hanger portions 26 and box 12 as known in the art. When there is only one tray-holder hanger 24 (one set of parallel hanger portions 26) provided with the box 12, each of the parallel hanger portions 26 may be permanently attached to the box by means known in the art, for example by glue or by welding, or it may temporarily be attached as discussed above.

Inside the box 12 are preferably two cup holder rings 22, attached to the back side 16 of the box 12. The cup holder rings 22 are cylinders of metal or plastic, preferably about 1 inch high, with a cylinder diameter of about 2 1/2 inches; however, the tray 10 of the invention may be made with other cup holder dimensions for particular purposes as desired. The means of attachment of the cup holder rings 22 to the back side 16 of the box 12 is as known in the art for a strong attachment, such as by screws, glue or welding.

The travel utility tray of the invention may be decorated in numerous ways as known in the art, during the manufacturing process or by the owner. Preferred decorations include decorative fabric and ribbon attached to the inside and outside of the box.

Preferably the travel utility tray 10 of the invention is always used with a trash bag 46 attached to the front portions 36 of the parallel hanger portions 26. Any bag, for example a ZIPLOCKTM bag, or any plastic bag or plastic lined paper bag, such as a bag made for the purpose of use with the invention herein so that it may be hung from the hanger portions 26, may be attached to the front portions 36 of the two parallel hanger portions 26 by simply puncturing the bag so that it hangs on the front portions, using the upper points of the front portions. For a bag with a reinforced area near the top of the bag, puncturing the bag near the top but below the reinforced area of the bag allows the bag to be more securely attached. If the bag has an upper handle, the handle may be placed over the front portions of the parallel portions.

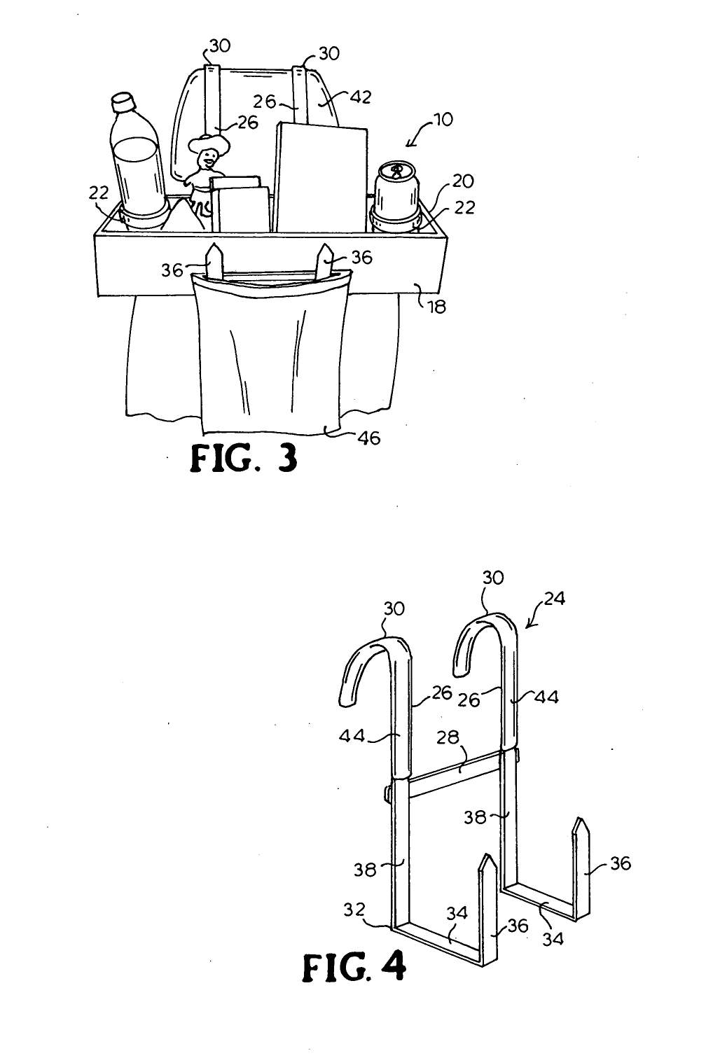

The travel utility tray 10 of the invention herein can hang on several areas of the car, including on the back 42 of either front seat as shown in FIG. 3, the steering wheel 40 as shown in FIG. 2, on the side door panel, or the middle console of the car, so that both hands may be used and are not required to hold the tray. It is clear that the person using the tray must not be driving during use of the tray, and that when the car is being driven, the tray should not be hung in a location to interfere with the driving of the car. While the invention has been described with reference to specific embodiments, it will be appreciated that numerous variations, modifications, and embodiments are possible, and accordingly, all such variations, modifications, and embodiments are to be regarded as being within the spirit and scope of the invention.

What is claimed is:

1. A travel utility tray for use in a vehicle, comprising:
a) a box having a rectangular base, a back side, a front side and two ends;
b) a tray-holder hanger comprising two parallel hanger portions and a cross- member holding the parallel hanger portions together, each hanger portion comprising an upper curved end that is sized to hang over an interior portion of a vehicle, and a lower tray-holder end having a flat lower portion between a front and back portion, so that the box fits snugly on the flat lower portion and is held there by the front and back portions of the two parallel hanger portions;
c) a means of attaching each parallel hanger portion to the box; and
d) two cup holder rings, each cup holder ring attached to the back side of the box.

2. The travel utility tray of claim 1, wherein the front portions of the two parallel hanger portions have pointed ends.

3. The travel utility tray of claim 1, further comprising decorative fabric and ribbon attached to the box.

4. The travel utility tray of claim 1, further comprising a trash bag attached to the front portions of the parallel hanger portions.
